(19) United States
(12) Patent Application Publication
(10) Pub. No.: US 2008/0084400 A1
(43) Pub. Date: Apr. 10, 2008

(54) TOUCH-GESTURE CONTROL OF VIDEO MEDIA PLAY ON HANDHELD MEDIA PLAYERS

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/682,872

(22) Filed: Mar. 6, 2007

Related U.S. Application Data
(60) Provisional application No. 60/850,550, filed on Oct. 10, 2006.

(51) Int. Cl. G06F 3/041

(52) U.S. Cl. 345/173

(57) ABSTRACT

A video media player for controlling the playback of video media in response to one or more finger gestures performed over the displayed image of a playing video media file. A display is adapted to display the video media. A touch screen surface is disposed in a position on the display. A processor is adapted to receive data from the touch screen surface and detect whether a user touches an area of the touch screen surface at least partially over an area of the display on which the video media is being displayed. The processor also determines whether the user has imparted a predetermined gesture on the touch screen surface. The processor further performs a corresponding action relating to the playback of the video media in response to determining that the user has imparted the predetermined gesture.

### RELATED APPLICATION DATA

This application claims priority to provisional application Ser. No. 60/850,550, filed Oct. 10, 2006, the disclosure of which is hereby incorporated by reference herein in its entirety.

### FIELD OF THE APPLICATION

The present invention relates to gesture recognition functions for handheld media devices.

### BACKGROUND

A standard set of user interface commands are currently employed by most systems that display video media, enabling a user to control the flow of media video media play. Such standard user interface commands include PLAY, PAUSE, REWIND, FAST FORWARD, and STOP. In addition, systems that play track-based video media such as DVD video media generally also include TRACK FORWARD and TRACK BACKWARDS, to skip forward or backwards by track increments respectively. In addition, systems that play video media generally also include user interface commands such as VOLUME UP and VOLUME DOWN for adjusting the audio volume of the audio component of the video media content. Finally, many systems that play video based media also include user interface commands to enable SLOW MOTION and FRAME ADVANCE for controlling frame by frame video playback at substantially slower than normal speeds.

In a typical television-based video media playing system, the aforementioned user interface commands are generally enabled through a handheld remote control where discrete buttons are associated with each user interface command. A user engages a command by pressing the button. For certain commands, like FAST FORWARD or VOLUME UP, the buttons are generally held over a period of time such that the duration of button engagement by the user controls the amount of fast forward or volume increase. Thus, a standard remote control generally provides a plurality of physical buttons for user engagement, each of the buttons being relationally associated with one of the standard set of video media control user interface commands. The user engages the commands by pressing specific buttons and/or by pressing and holding specific buttons. FIG. 1A illustrates an example of a typical current remote control 100 according to the prior art. As shown, the remote control 100 includes discrete physical buttons for the common video-media related user interface commands.

In a typical computer-based video media playing system, the aforementioned user interface commands are generally enabled through simulated soft-buttons that are drawn upon a portion of the display screen that is separate from the video display portion of the screen. For example, Windows™ Media Player™ from Microsoft™, Quicktime™ from Apple™, and Realplayer™ from Real Networks™ are examples of computer based video media playing software applications that provide users with soft-button controls for performing the common video-media related user interface commands. FIGS. 1B and 1C illustrate screen drawn buttons 105 and 110 are placed beside or under the playing video content to enable a user to perform the common video-media related user interface commands. In general a pointing device, such as a mouse or a touch screen, is used to enable a user to press the simulated soft-buttons in much the same way they would engage real-physical buttons upon a handheld remote control. While such systems are well suited desktop computer displays and/or laptop displays that have large screens, they are non-ideal for small handheld video media playing devices because the soft buttons take up screen space that otherwise could be used for displaying video. Thus, in general the use of soft buttons to enable common video media user interface commands has the drawback of taking up screen space and thus reducing the playing size the video content itself.

Some systems of the current art partially address this problem by having soft buttons disappear from the screen after a certain amount of time, only to return after a user engages the mouse or other pointing device of the computer system. This does help address the screen space issue, for the video display area is only reduced during certain time periods, but it instead creates a two step process for users wherein they must first cause the system to display the soft buttons and then they must engage the soft buttons. This is often more cumbersome and time consuming for users. What is thus needed is an improved method of enabling common video media related user interface commands upon a touch screen enabled handheld media player without requiring actual physical buttons or the display of simulated soft buttons (or other graphical user interface elements) that take up screen space that otherwise could be used for displaying video media. Furthermore what is needed is a method that does not introduce a two-step process wherein soft buttons must first be made to appear and then must be engaged by a user.

### SUMMARY

Embodiments of the present invention are directed to methods, apparatus, and computer program products that enable a user of a media player to control the playing of a piece of video media by imparting unique touch gestures upon the screen of the media player. More specifically, the embodiments of the present invention comprises a portable media player with a touch screen interface, the portable media player configured to selectively control the playing of a piece of video media in response to a user imparting a unique touch gesture upon the screen of the media player at a location that is directly over the playing video media content. The embodiments are configured such that the user may engage the touch screen using one of a plurality unique touch gestures. In response to detecting one of said plurality of unique touch gestures, routines of embodiments of the present invention impart a video media control function, the video media control function including one of play, pause, rewind, fast-forward, volume up, volume down, track forward, track backwards, slow motion, and frame advance. Each video media control function is relationally associated with a unique touch gesture. In this way a variety of video media play control functions may be enabled upon a touch screen enabled portable media player without the use of soft buttons or real physical buttons. Because the user imparts the unique touch gesture directly over the playing media file to be controlled, no screen space is wasted upon dedicated graphical control elements. This saves space and provides for a natural and intuitive user interface methodology for users.

In a preferred embodiment, a static finger gesture is enabled in which a user touches a finger anywhere within the display area of the playing video media content, and holds the finger there for more than a threshold amount of time without substantially moving the location of the finger upon the screen. In response to the detection of a static finger gesture imparted within the display area of a playing piece of video media, the playing piece of video media is paused by routines of embodiments of the present invention.

In a preferred embodiment, a rightward-swipe finger gesture is enabled in which a user touches a finger within the display area of the playing video media content and slides it to the right open the playing video media content with a speed that falls within certain bounds. In a preferred embodiment the rightward-swipe finger gesture is mapped to a FAST FORWARD video media control function.

In a preferred embodiment, a leftward-swipe finger gesture is enabled in which a user touches a finger within the display area of the playing video media content and slides it to the left across the playing video media content with a speed that falls within certain bounds. In a preferred embodiment the leftward-swipe finger gesture is mapped to a REWIND video media control function.

In a preferred embodiment, an upward-swipe finger gesture is enabled in which a user touches a finger within the display area of the playing video media content and slides it upward across the playing video media content with a speed that falls within certain bounds. In a preferred embodiment the upward-swipe finger gesture is mapped to a VOLUME UP video media control function.

In a preferred embodiment, a downward-swipe finger gesture is enabled in which a user touches a finger within the display area of the playing video media content and slides it downward across the playing video media content with a speed that falls within certain bounds. In a preferred embodiment the downward-swipe finger gesture is mapped to a VOLUME DOWN video media control function.

In a preferred embodiment, a double-tap finger gesture is enabled in which in which a user taps twice in rapid succession upon the display area of the playing video media content that is currently paused, being fast-forwarded, or being rewound. In a preferred embodiment the double-tap finger gesture is mapped to a RESUME PLAY video media control function.

In a preferred embodiment, circular-swipe finger gesture is enabled in which a user slides a finger in a circular motion upon the display area of the playing video media content. In a preferred embodiment the circular-swipe finger gesture is mapped to a PLAY FROM BEGINNING video media control function.

In a preferred embodiment, a two-finger rightward-swipe finger gesture is enabled in which a user touches two fingers within the display area of the playing video media content and slides them to the right open the playing video media content with a speed that falls within certain bounds. In a preferred embodiment the two finger rightward-swipe finger gesture is mapped to a TRACK FORWARDS video media control function.

In a preferred embodiment, a two-finger leftward swipe finger gesture is enabled in which a user touches two fingers within the display area of the playing video media content and slides them to the left open the playing video media content with a speed that falls within certain bounds. In a preferred embodiment the two finger leftward-swipe finger gesture is mapped to a TRACK BACKWARDS video media control function.

In some embodiments a diagonal-swipe finger gesture may be enabled in which the user slides a finger from the upper left portion of a playing video media file towards a lower right portion of a playing video media file. In some such embodiments a diagonal-swipe finger gesture is mapped to a video media close function such that the playing video media file upon which the gesture was performed is stopping and closed. This is a fast and convenient way to end the playing of a video media file and close it such that other computing content may be displayed upon the screen.

The above summary of the present invention is not intended to represent each embodiment or every aspect of the present invention. The detailed description and figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1A illustrates an example of a typical current remote control according to the prior art;

FIGS. 1B and 1C illustrate screen drawn buttons that are placed beside or under the playing video content to enable a user to perform the common video-media related user interface commands according to the prior art.

FIG. 2 illustrates an example of such a handheld media player according to at least one embodiment of the invention;

FIG. 3 illustrates the basic components of computer according to at least one embodiment of the invention;

FIGS. 4A and 4B illustrate a figural depiction of a static finger gesture according to at least one embodiment of the invention;

FIGS. 5A and 5B illustrate a figural depiction of a rightward-swipe finger gesture according to at least one embodiment of the invention;

FIGS. 6A and 6B illustrate a leftward-swipe finger gesture according to at least one embodiment of the invention;

FIGS. 7A and 7B illustrate a figural depiction of an upward-swipe finger gesture according to at least one embodiment of the invention;

FIGS. 8A and 8B illustrate a figural depiction of a downward-swipe finger gesture according to at least one embodiment of the invention;

FIGS. 9A and 9B illustrate a figural depiction of a circular-swipe finger gesture according to at least one embodiment of the invention;

FIGS. 10A and 10B illustrate a figural depiction of a two-finger rightward-swipe finger gesture according to at least one embodiment of the invention; and

FIGS. 11A and 11B illustrate a figural depiction of a two-finger leftward-swipe finger gesture according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the invention are directed to methods, apparatus, and computer program products for enabling finger gesture control of playing video media without the use of graphical soft buttons or other screen-occupying user interface elements. In this way a playing video file may be paused, fast-forwarded, rewound, increased in audio play volume, decreased in audio play volume, restarted from the beginning, and/or advanced or retreated by one play track, in response to on-media finger gestures that are performed directly over the playing video media itself. This enables handheld media players to be configured such that the playing video media may occupy a substantial portion of the frontal area of the hardware unit without wasting screen space on graphical user interface elements that are typically required for video media play control and/or without introducing a two-step process wherein graphical controls must be brought to the foreground for display. In this way embodiments of the present invention provide for a more efficient use of screen space while still enabling a convenient and natural interface for play control of video media. In addition, embodiments of the present invention enable video play control to be performed by a user without the requiring the user to dexterously target small graphical buttons, sliders, or other traditional elements used in video play control. Thus, embodiments of the present invention are easier to use than traditional methods.

A touch screen is a unique user interface element because it functions both as an output of visual content and as an input for manual control. A traditional touch screen interface enables a user to provide input to a graphical user interface (“GUI”) by manually touching the surface of the screen as a means of targeting and selecting displayed graphical elements. In general, simulated buttons, icons, sliders, and/or other displayed elements are engaged by a user by directly touching the screen area at the location of the displayed user interface element. For example, if a user wants to target and select a particular icon, button, hyperlink, menu element, or other displayed element upon the screen, the user touches the actual location upon the screen at which that desired element is displayed. Some touch screen systems enable more complex interactions, such as bi-modal finger engagement as is disclosed in co-pending U.S. Provisional Patent Application Ser. No. 60/786,417 by the present inventor, the disclosure of which is hereby incorporated by reference. Other touch screen systems have been disclosed in pending U.S. patent applications that enable multi-finger touch screen controls and gestures, including Ser. No. 10/840,862 and Patent Application Publication Nos. 2006/0026521 and 2006/0022955, the disclosures of which are all also hereby incorporated by reference.

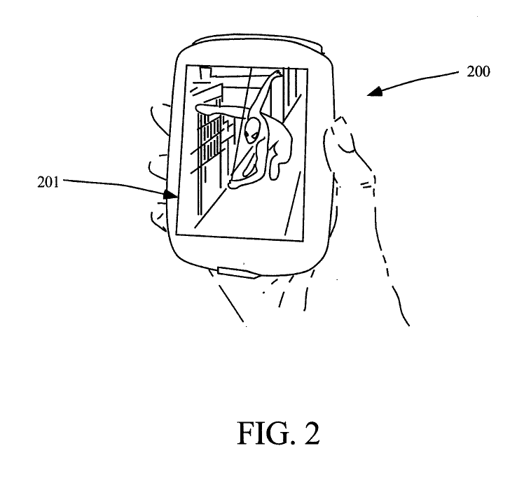

Touch screens are highly preferred interface components in compact handheld media players systems that display video content because they enable screen areas that take up a large percentage of the total size of the handheld unit. This is because physical space need not be used on traditional physical buttons and controls. Instead, user input can be enabled through the use of simulated buttons and controls upon the screen display area. Thus, touch screen equipped video media players may be comprised such that the display screen takes up almost the entire frontal surface of the handheld unit. FIG. 2 illustrates an example of such a handheld media player 200 according to at least one embodiment of the invention. As shown, the display screen 201 takes up almost all of the frontal surface area of the handheld unit 200. In this way, video media files such as movies, music videos, and other digital movie files may be displayed to a user upon the screen 201 of the handheld unit 200 at a display size that takes up substantially all of the frontal surface area of the unit. In the example shown in FIG. 2, the movie Spider Man™ is being displayed upon the screen with a size that takes up substantially all of the frontal area of the handheld media player 200. Typically a user listens to the audio content through headphones and/or speakers of the media player unit.

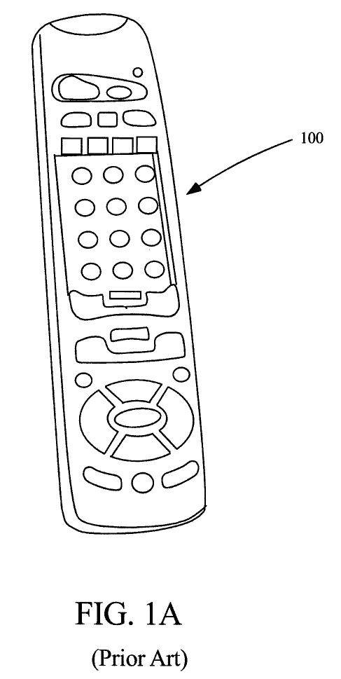

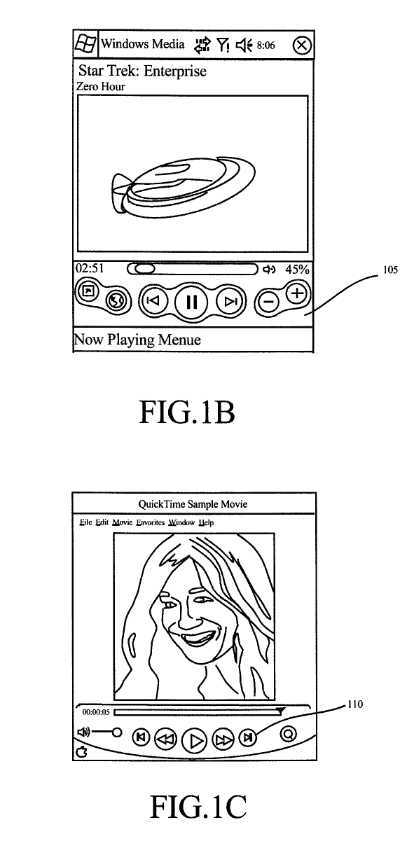

There is still the issue of the user interface controls for enabling the user to control the display of video content upon the portable media player 200. In a typical handheld media player of the current art that employ touch screen interfaces, user interface controls for video media display are enabled using soft buttons or other displayed graphical elements upon a portion of the touch screen display area that is not being used for displaying the actual video media content. Displayed elements may include displayed buttons, sliders, or other graphical controls that enable common media control functions such as play, rewind, fast-forward, pause, stop, volume up, volume down, track forward, track backwards, slow motion, and frame advance. A variety of visual layouts may be employed for media control soft buttons, sliders, and other graphical control elements. Examples layouts for the screen area are shown in FIGS. 1B and 1C as they would be employed by common media display applications such as Windows Media Player™ and Apple QuickTime™. As was described above, such use of soft button and/or other graphical control elements take up screen space and thus reduce the size of displayed video content upon the screen.

Embodiments of the present invention address this problem by providing an alternate means of enabling common user interface controls of video media display through a touch screen interface. More specifically, the embodiments of the present invention enable common video media user interface commands to be triggered by intuitive and easy to execute touch gestures that are preformed upon the touch screen, by the user, within the display area of the screen that is actually playing a piece of video media content. In other words, embodiments of the present invention enable the user to perform touch gestures directly over the playing video content, the touch gestures enabling common user interface controls without the need for soft buttons or other graphical elements that take up screen space. In this way physical buttons and/or soft buttons are not needed, enabling instead a simple, elegant, and clutter free user interface methodology for controlling video media touch screen enabled handheld media players.

As described below, the touch gestures enabled by embodiments of the present invention are such that the user may simply touch his finger to the screen area that corresponds with the actual playing video media content in one of a plurality of characteristic ways. Each of the characteristic ways is referred to herein as a “touch gesture” and is mapped in software to a particular control function of the video media content. Thus, a plurality of touch gestures are enabled by the routines of embodiments of the present invention, where each of the touch gestures require the user to move his finger upon the portion of the touch screen that is currently displaying the video media content in a characteristic manner, and each of the touch gestures is mapped to a different control function of the video media content. The video media control functions include at least a plurality of play, pause, rewind, fast-forward, volume up, volume down, track forward, track backwards, slow motion, and frame advance control functions upon the playing video media content.

In this way the user of an embodiment of the present invention may touch the display screen 201 of the portable media player 200 at a location that is directly over a piece of playing video media content, the finger engaging the screen in one of a plurality of characteristic ways, each of the characteristic ways comprising a unique touch gesture. In response to detecting one of said plurality of unique touch gestures, the routines of embodiments of the present invention are configured to perform a control command upon that piece of playing video media, the control functions including one of play, pause, rewind, fast-forward, volume up, volume down, track forward, track backwards, rewind to start, slow motion, and frame advance, the particular video media control functions being relationally associated with the unique touch gesture. In this way a variety of video media control functions may be enabled upon a touch screen enabled portable media player without the use of soft buttons (or other graphical display elements) and without the use of real physical buttons. This provides savings of screen space and a convenience for the user.

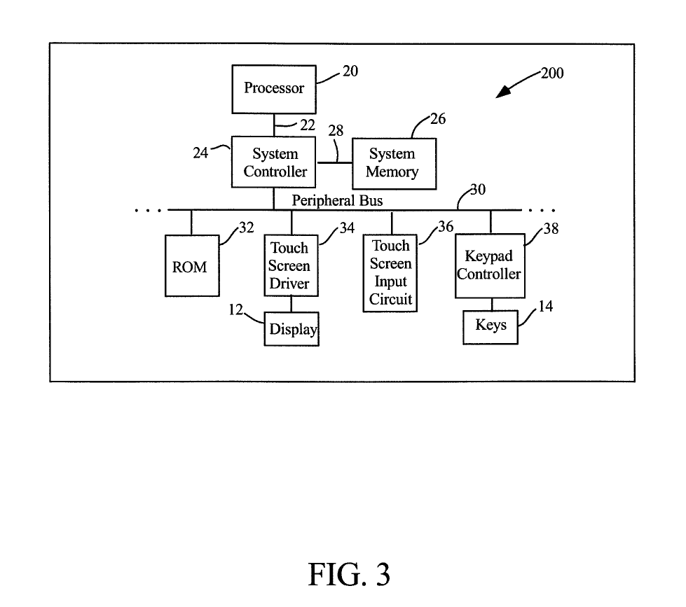

Referring again to FIG. 2, a handheld computer 200 is illustrated that employs a touch screen 201 configured to track the location of a touch engagement by the user. FIG. 3 illustrates the basic components of computer 200 according to at least one embodiment of the invention. As shown in FIG. 2, computer 200 is of the type that is adapted to be held in the hand of an operator during typical use. Such computers 200, often known as “palmtop” computers, include a display screen 201 that takes up a large portion of the frontal surface area but is still relatively small compared to a traditional desktop computer or laptop computer. Because the screen is generally made as large as can reasonably be fit within the handheld size of the device, relatively few, if any, manually actuated keys are provided. The display screen 201 is a touch screen that is used as the primarily controls the operation of the computer 200. During some modes of operation, a graphical user interface is displayed upon the screen, including buttons, icons, sliders, menus, and other GUI elements known to the art.

The basic components of computer 200 are shown in the system block diagram of FIG. 3. The computer 200 includes a processor 20 of conventional design that is coupled through a processor bus 22 to a system controller 24. The processor bus 22 generally includes a set of bidirectional data bus lines coupling data to and from the processor 20, a set of unidirectional address bus lines coupling addresses from the processor 20, and a set of unidirectional control/status bus lines coupling control signals from the processor 20 and status signals to the processor 20. The system controller 24 performs two basic functions. First, it couples signals between the processor 20 and a system memory 26 via a memory bus 28. The system memory 26 is normally a dynamic random access memory (“DRAM”), but it may also be a static random access memory (“SRAM”). Second, the system controller 24 couples signals between the processor 20 and a peripheral bus 30. The peripheral bus 30 is, in turn, coupled to a read only memory (“ROM”) 32, a touch screen driver 34, a touch screen input circuit 36, and a keypad controller 38.

The ROM 32 stores a software program for controlling the operation of the computer 200, although the program may be transferred from the ROM 32 to the system memory 26 and executed by the processor 20 from the system memory 26. The software program may include the specialized routines described herein for enabling the touch-gesture control of video media using some or all of the unique plurality of on-video gestures disclosed herein. For example, the software routines running upon computer 200 may be used to pause the play of a video media file in response to a static touch gesture imparted by the user upon the screen area of the playing video media file. Similarly, the software routines running upon computer 200 may be used to fast-forward the play of a video media file in response to a rightward-swipe touch gesture imparted by the user upon the screen area of the playing video media file. The software routines running upon computer 200 may also be used to rewind the play of a video media file in response to a leftward-swipe touch gesture imparted by the user upon the screen area of the playing video media file. The software routines running upon computer 10 may further be used to increase the audio volume of the play of a video media file in response to an upward-swipe touch gesture imparted by the user upon the screen area of the playing video media file. Similarly, the software routines running upon computer 200 may be used to decrease the audio volume of the play of a video media file in response to a downward-swipe touch gesture imparted by the user upon the screen area of the playing video media file. The software routines running upon computer 200 may also be used to resume the play of a paused, fast-forwarding, or rewinding, video media file in response to a double-tap touch gesture imparted by the user upon the screen area of the playing video media file. The software routines running upon computer 200 may further be used to jump play to the beginning of a playing video media file in response to a circular-swipe touch gesture imparted by the user upon the screen area of the playing video media file. Similarly, the software routines running upon computer 200 may be used to jump one track forward in the play of a video media file in response to a two-finger rightward-swipe touch gesture imparted by the user upon the screen area of the playing video media file. The software routines running upon computer 200 may additionally be utilized to jump one track backwards in the play of a video media file in response to a two-finger leftward-swipe touch gesture imparted by the user upon the screen area of the playing video media file. These routines may be in hardware and/or software and may be implemented in a variety of ways. For example, they may part of a touch screen driver and/or as part of a GUI controller and/or as part of a video media play application that governs the play and control of video media content.

There are many unique gestures that may be made by the user. In a preferred embodiment, a static finger gesture is enabled in which a user touches a finger anywhere within the display area of the playing video media content, and holds the finger there for more than a threshold amount of time without substantially moving the location of the finger upon the screen. In one such embodiment the threshold amount of time is 2000 milliseconds. In a preferred embodiment the static finger gesture is mapped to a PAUSE video media control function. Thus, in response to the detection of a static finger gesture imparted within the display area of a playing piece of video media, the playing piece of video media is paused by the routines discussed herein.

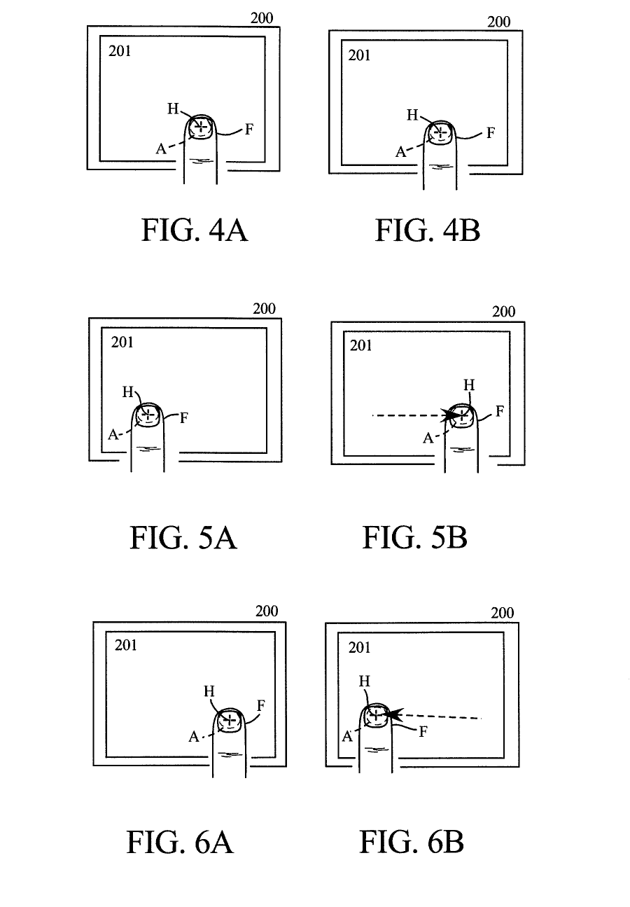

FIGS. 4A and 4B illustrate a figural depiction of a static finger gesture according to at least one embodiment of the invention. As shown, a touch screen display screen 201 of media player 200 is currently playing a video media file (not shown) to a user upon the screen. In this example the video media file is filling the entire screen area of display screen 201. Thus the video media file display area corresponds with the full screen area 201. That said, in other embodiments the video media display area may be a sub-area of screen area 201. In such embodiments, the user generally performs the static finger gesture upon the sub-area of screen 201 that corresponds with the video display area. In this example, the distinction need not be made.

Referring back to FIGS. 4A and 4B, each figure represents a first moment in time and a second moment in time respectively. At the first moment in time as shown in FIG. 4A, finger F engages the touch screen a first location within the screen area 201 while the video media file is playing within that screen area. The finger contacts the screen over an area represented by ellipse A and is generally resolved by the touch screen driver to a single contact point H. Upon detection of the finger contact, the routines of embodiments of the present invention determine changes in the contact location H over a period of time. If at a second moment in time, finger F remains at substantially the same location as at the first moment in time, the routines of the present invention determine that a static finger gesture has been performed by the user. FIG. 4B represents such a second moment in time. In general the routines are configured to require that the elapsed time between the first moment time and the second moment in time exceed a predefined time threshold. In one embodiment a time threshold of 2000 milliseconds is employed as described previously. Thus if finger F remains in contact with touch screen 201 for more than 2000 milliseconds while also remaining substantially at the same location H upon the screen, a static finger gesture is determined by the routines of the present invention. By substantially the same location, it generally means that changes in location H are less than some predefined small threshold. In one embodiment the small threshold is 30% of the major axis of finger contact ellipse A. In response to the detection of a static finger gesture imparted within the display area of a playing piece of video media, the playing piece of video media is paused by embodiments implementing the routines of the present invention.

In a preferred embodiment, a rightward-swipe finger gesture is enabled in which a user touches a finger within the display area of the playing video media content and slides it to the right open the playing video media content with a speed that falls within certain bounds. In a preferred embodiment the rightward-swipe finger gesture is mapped to a FAST FORWARD video media control function. Thus, in response to the detection of a rightward-swipe finger gesture imparted within the display area of a playing piece of video media, the playing piece of video media is fast-forwarded by embodiments implementing routines of the present invention. In some embodiments, the speed of the fast-forward function is dependent at least in part upon the speed of the rightward-swipe finger gesture. In other embodiments, the speed of the fast-forward function is dependent at least in part upon the number of sequential rightward-swipe finger gestures imparted by the user.

FIGS. 5A and 5B illustrate a figural depiction of a rightward-swipe finger gesture according to at least one embodiment of the invention. As shown, a touch screen display screen 201 of media player 200 is currently playing a video media file (not shown) to a user upon the full screen area.

FIGS. 5A and 5B represent a first moment in time and a second moment in time respectively. At the first moment in time, finger F engages the touch screen a first location within the screen area 201 while the video media file is playing within that screen area. Upon detection of the finger contact, the routines of embodiments of the present invention determine changes in the contact location H over a period of time. If at a second moment in time, finger F has moved substantially to the right, the routines determine that a rightward finger gesture has been performed by the user. FIG. 5B represents such a second moment in time, with the dotted arrow representing the rightward motion that the finger undertook. The routines may be configured to require that the elapsed time between the first moment time and the second fall within certain limits. In one embodiment a minimum threshold of 200 milliseconds is employed and a maximum time threshold of 4000 milliseconds is employed. Thus, if finger F moves substantially to the right within the certain time limits, a rightward finger gesture is determined by the routines of the present invention to have been performed upon the playing video media file. By “substantially to the right,” it is generally meant that rightward changes in location H are more than some predefined small threshold. In one embodiment the small threshold is 300% of the major axis of finger contact ellipse A. In response to the detection of a rightward finger gesture imparted within the display area of a playing piece of video media, the playing piece of video media is fast-forwarded by the routines of embodiments of the present invention. In some embodiments the distance moved and/or the speed of motion is also quantified by the routines. In some such embodiments the speed of the fast-forward function is dependent at least in part upon the speed of the rightward-swipe finger gesture. The speed of the fast-forward function may be dependent at least in part upon the distance of the rightward-swipe finger gesture. In other embodiments, the speed of the fast-forward function is dependent at least in part upon the number of sequential rightward-swipe finger gestures imparted by the user as detected by the routines of the present invention.

In a preferred embodiment, a leftward-swipe finger gesture is enabled in which a user touches a finger within the display area of the playing video media content and slides it to the left across the playing video media content with a speed that falls within certain bounds. In a preferred embodiment the leftward-swipe finger gesture is mapped to a REWIND video media control function. Thus in response to the detection of a leftward-swipe finger gesture imparted within the display area of a playing piece of video media, the playing piece of video media is played in reverse by the routines of embodiments of the present invention. In some embodiments, the speed of the rewind function is dependent at least in part upon the speed of the leftward-swipe finger gesture. In other embodiments, the speed of the rewind function is dependent at least in part upon the number of sequential leftward-swipe finger gestures imparted by the user.

FIGS. 6A and 6B illustrate a leftward-swipe finger gesture according to at least one embodiment of the invention. As shown, a touch screen display screen 201 of media player 200 is currently playing a video media file (not shown) to a user upon the full screen area.

FIGS. 6A and 6B represent a first moment in time and a second moment in time respectively. At the first moment in time, finger F engages the touch screen a first location within the screen area 201 while the video media file is playing within that screen area. Upon detection of the finger contact, the routines of embodiments of the present invention determine changes in the contact location H over a period of time. If at a second moment in time, finger F has moved substantially to the left, the routines determine that a leftward finger gesture has been performed by the user. FIG. 6B represents such a second moment in time, the dotted arrow representing the leftward motion that the finger undertook. The routines may be configured to require that the elapsed time between the first moment time and the second falls within certain limits. In one embodiment a minimum threshold of 200 milliseconds is employed and a maximum time threshold of 4000 milliseconds is employed. Thus if finger F moves substantially to the left within the certain time limits, a leftward finger gesture is determined to have been performed upon the playing video media file. By “substantially to the left,” it is generally meant that rightward changes in location H are more than some predefined small threshold. In one embodiment the small threshold is 300% of the major axis of finger contact ellipse A. In response to the detection of a leftward finger gesture imparted within the display area of a playing piece of video media, the playing piece of video media is rewound by the routines of the present invention. In some embodiments the distance moved and/or the speed of motion is also quantified. In some such embodiments the speed of the rewind function is dependent at least in part upon the speed of the leftward-swipe finger gesture. In some such embodiments the speed of the rewind function is dependent at least in part upon the distance of the leftward-swipe finger gesture. In other embodiments, the speed of the rewind function is dependent at least in part upon the number of sequential leftward-swipe finger gestures imparted by the user as detected by the routines.

In a preferred embodiment, an upward swipe finger gesture is enabled in which a user touches a finger within the display area of the playing video media content and slides it upward across the playing video media content with a speed that falls within certain bounds. In a preferred embodiment the upward-swipe finger gesture is mapped to a VOLUME UP video media control function. Thus in response to the detection of an upward-swipe finger gesture being imparted within the display area of a playing piece of video media, the audio content of the playing piece of video media is played is increased in volume by the routines of embodiments of the present invention. In some embodiments, the amount of volume increase is dependent at least in part upon the distance covered by the upward swipe finger gesture across the screen. In some embodiments, the amount of volume increase is dependent at least in part upon the speed of the upward-swipe finger gesture. In other embodiments, the amount of volume increase is dependent at least in part upon the number of sequential upward-swipe finger gestures imparted by the user.

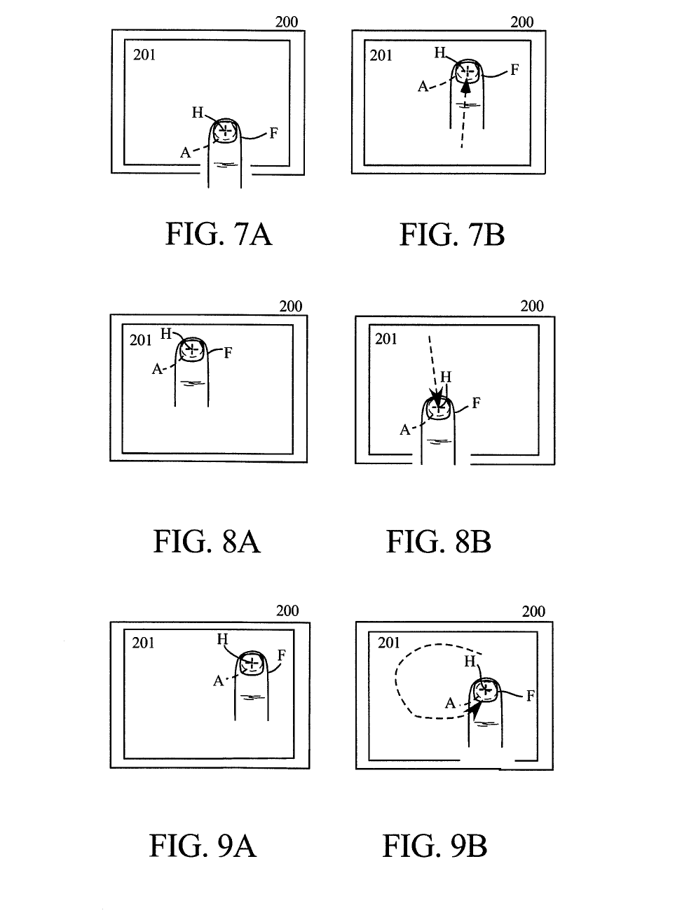

FIGS. 7A and 7B illustrate a figural depiction of an upward-swipe finger gesture according to at least one embodiment of the invention. As shown, a touch screen display screen 201 of media player 200 is currently playing a video media file (not shown) to a user upon the full screen area, the audio being displayed through speakers and/or headphones (also not shown). FIGS. 7A and 7B represent a first moment in time and a second moment in time respectively. At the first moment in time, finger F engages the touch screen a first location within the screen area 201 while the video media file is playing within that screen area. Upon detection of the finger contact, the routines of embodiments of the present invention determine changes in the contact location H over a period of time. If at a second moment in time, finger F has moved substantially upward, the routines determine that an upward finger gesture has been performed by the user. FIG. 7B represents such a second moment in time, the dotted arrow representing the upward motion that the finger undertook. The routines may be configured to require that the elapsed time between the first moment time and the second fall within certain limits. In one embodiment a minimum threshold of 200 milliseconds is employed and a maximum time threshold of 4000 milliseconds is employed. Thus if finger F moves substantially upward within the certain time limits, an upward finger gesture is determined by the routines to have been performed upon the playing video media file. By “substantially upward,” it is generally meant that upward changes in location H are more than some predefined small threshold. In one embodiment the small threshold is 300% of the major axis of finger contact ellipse A. In response to the detection of an upward finger gesture imparted within the display area of a playing piece of video media, the audio volume of the playing piece of video media is increased. In some embodiments the distance moved and/or the speed of motion is also quantified by the routines of the present invention. In some such embodiments the amount of volume increase is dependent at least in part upon the speed of the upward-swipe finger gesture. In some such embodiments the amount of volume increase is dependent at least in part upon the distance of the upward-swipe finger gesture. In some embodiments, the amount of volume increase is dependent at least in part upon the number of sequential upward-swipe finger gestures imparted by the user as detected by the routines of embodiments of the present invention.

In a preferred embodiment, a downward swipe finger gesture is enabled in which a user touches a finger within the display area of the playing video media content and slides it downward across the playing video media content with a speed that falls within certain bounds. In a preferred embodiment the downward-swipe finger gesture is mapped to a VOLUME DOWN video media control function. Thus in response to the detection of an downward-swipe finger gesture imparted within the display area of a playing piece of video media, the audio content of the playing piece of video media is played is decreased in volume. In some embodiments, the amount of volume decrease is dependent at least in part upon the distance covered by the downward swipe finger gesture across the screen. In some embodiments, the amount of volume decrease is dependent at least in part upon the speed of the downward-swipe finger gesture. In other embodiments, the amount of volume decrease is dependent at least in part upon the number of sequential downward-swipe finger gestures imparted by the user.

FIGS. 8A and 8B illustrate a figural depiction of a downward-swipe finger gesture according to at least one embodiment of the invention. As shown, a touch screen display screen 201 of media player 200 is currently playing a video media file (not shown) to a user upon the full screen area, the audio being displayed through speakers and/or headphones (also not shown). FIGS. 8A and 8B represent a first moment in time and a second moment in time respectively. At the first moment in time, finger F engages the touch screen a first location within the screen area 201 while the video media file is playing within that screen area. Upon detection of the finger contact, the routines of the present invention determine changes in the contact location H over a period of time. If at a second moment in time, finger F has moved substantially downward, the routines of the present invention determine that a downward finger gesture has been performed by the user. FIG. 8B represents such a second moment in time, the dotted arrow representing the downward motion that the finger undertook. The routines may be configured to require that the elapsed time between the first moment time and the second fall within certain limits. In one embodiment a minimum threshold of 200 milliseconds is employed and a maximum time threshold of 4000 milliseconds is employed. Thus if finger F moves substantially downward within the certain time limits, an downward finger gesture is determined by the routines of the present invention to have been performed upon the playing video media file. By “substantially downward,” it is generally meant that downward changes in location H are more than some predefined small threshold. In one embodiment the small threshold is 300% of the major axis of finger contact ellipse A. In response to the detection of a downward finger gesture imparted within the display area of a playing piece of video media, the audio volume of the playing piece of video media is decreased. In some embodiments the distance moved and/or the speed of motion is also quantified by the routines of the present invention. In some such embodiments the amount of volume decrease is dependent at least in part upon the speed of the downward-swipe finger gesture. In some such embodiments the amount of volume decrease is dependent at least in part upon the distance of the downward-swipe finger gesture. In some embodiments, the amount of volume decrease is dependent at least in part upon the number of sequential downward-swipe finger gestures imparted by the user as detected by the routines of embodiments of the present invention.

In a preferred embodiment, a double-tap finger gesture is enabled in which in which a user taps twice in rapid succession upon the display area of the playing video media content that is currently paused, being fast-forwarded, or being rewound. In a preferred embodiment the double-tap finger gesture is mapped to a RESUME PLAY video media control function. Thus in response to the detection of a double-tap finger gesture imparted within the display area of a playing piece of video media, the media content is caused to resume normal forward play. The double-tap finger gesture may be determined using the same methods as used for the static finger gesture with the one caveat that the finger must be detected as having left contact with the screen between the first moment in time shown in FIG. 4A and the second moment in time in FIG. 4B. Furthermore, in some embodiments the finger must have left the screen for more than a minimum time threshold, for example 150 milliseconds.

In a preferred embodiment, circular-swipe finger gesture is enabled in which in which a user slides a finger in a circular motion upon the display area of the playing video media content. In a preferred embodiment the circular-swipe finger gesture is mapped to a PLAY FROM BEGINNING video media control function. Thus in response to the detection of a circular-swipe finger gesture imparted within the display area of a playing piece of video media, the media content is automatically rewound all the way to the beginning and plays from there. In this way the circular motion causes a full rewind and replay of the playing media file.

FIGS. 9A and 9B illustrate a figural depiction of a circular-swipe finger gesture according to at least one embodiment of the invention. As shown, a touch screen display screen 201 of media player 200 is currently playing a video media file (not shown) to a user upon the full screen area, the audio being displayed through speakers and/or headphones (also not shown). FIGS. 9A and 9B each represents a first moment in time and a second moment in time respectively. At the first moment in time, finger F engages the touch screen a first location within the screen area 201 while the video media file is playing within that screen area. Upon detection of the finger contact, the routines determine changes in the contact location H over a period of time. If at a second moment in time, finger F has moved generally in a circular motion, the routines determine that circular-swipe finger gesture has been performed by the user. FIG. 9B represents such a second moment in time, with the dotted arrow representing the generally circular motion that the finger undertook. The routines of embodiments of the present invention may be configured to require that the elapsed time between the first moment time and the second fall within certain limits. In one embodiment a minimum threshold of 500 milliseconds is employed and a maximum time threshold of 5000 milliseconds is employed. Thus if finger F moves generally in a circular motion within the certain time limits, an circular-swipe finger gesture is determined to have been performed upon the playing video media file. In response to the detection of a generally circular finger gesture imparted within the display area of a playing piece of video media, the playing piece of video media is jumped back to the beginning of the media file and continues playing from there.

In a preferred embodiment, a two-finger rightward-swipe finger gesture is enabled in which a user touches two fingers within the display area of the playing video media content and slides them to the right open the playing video media content with a speed that falls within certain bounds. In a preferred embodiment the two finger rightward-swipe finger gesture is mapped to a TRACK FORWARDS video media control function. Thus in response to the detection of a two-finger rightward-swipe finger gesture imparted within the display area of a playing piece of video media, the playing piece of video media is jumped ahead by one track increment by the routines of the present invention. In some embodiments it jumps forward by one increment on a playlist of media files.

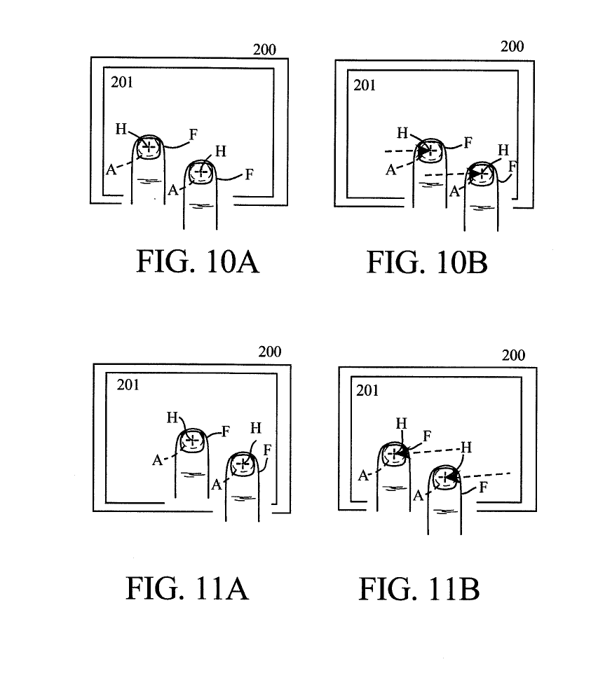

FIGS. 10A and 10B illustrate a figural depiction of a two-finger rightward-swipe finger gesture according to at least one embodiment of the invention. As shown, a touch screen display screen 201 of media player 200 is currently playing a video media file (not shown) to a user upon the full screen area. FIGS. 10A and 10B represent a first moment in time and a second moment in time respectively. At the first moment in time, two fingers engage the touch screen, each at a first location H within the screen area 201 while the video media file is playing within that screen area. Upon detection of the two-finger contact, the routines of embodiments of the present invention determine changes in the contact locations over a period of time. If at a second moment in time, the two fingers have each moved substantially to the right, the routines determine that a two-finger rightward finger gesture has been performed by the user. FIG. 10B represents such a second moment in time, the dotted arrows representing the rightward motion that each of the two fingers undertook. The routines may be configured to require that the elapsed time between the first moment time and the second fall within certain limits. In one embodiment a minimum threshold of 200 milliseconds is employed and a maximum time threshold of 4000 milliseconds is employed. Thus if each finger F moves substantially to the right within the certain time limits, a two-finger rightward finger gesture is determined by the routines to have been performed upon the playing video media file. By “substantially to the right,” it is generally meant that rightward changes in the location H of each finger are more than some predefined small threshold. In one embodiment the small threshold is 300% of the major axis of finger contact ellipse A of each finger. In response to the detection of a two-finger rightward finger gesture imparted within the display area of a playing piece of video media, the playing piece of video media is jumped forward by one track, for example by one track of a DVD or DVD style data stored in memory. If media is being played from a playlist that indicates a sequential listing of media items to be played, the playing piece of media may be advanced to the next item on the playlist in response to the detection of a two-finger rightward swipe finger gesture. In this way a user may, for example, be watching a music video in a sequence of music videos defined by a playlist. The user may advance to the next video in the playlist by simply performing a two-finger rightward swipe finger gesture upon the screen of the media player.

In a preferred embodiment, a two-finger leftward swipes finger gesture is enabled in which a user touches two fingers within the display area of the playing video media content and slides them to the left open the playing video media content with a speed that falls within certain bounds. In a preferred embodiment the two finger leftward-swipe finger gesture is mapped to a TRACK BACKWARDS video media control function. Thus, in response to the detection of a two-finger leftward-swipe finger gesture imparted within the display area of a playing piece of video media, the playing piece of video media is jumped back by one track increment by the routines of embodiments of the present invention. In some embodiments it jumps back by one increment on a playlist of media files.

FIGS. 11A and 11B illustrate a figural depiction of a two-finger leftward-swipe finger gesture according to at least one embodiment of the invention. As shown, a touch screen display screen 201 of media player 200 is currently playing a video media file (not shown) to a user upon the full screen area. FIGS. 11A and 11B represent a first moment in time and a second moment in time respectively. At the first moment in time, two fingers engage the touch screen, each at a first location H within the screen area 201 while the video media file is playing within that screen area. Upon detection of the two-finger contact, the routines of embodiments of the present invention determine changes in the contact locations over a period of time. If at a second moment in time, the two fingers have each moved substantially to the left, the routines determine that a two-finger leftward finger gesture has been performed by the user. FIG. 11B represents such a second moment in time, with the dotted arrows representing the leftward motion that each of the two fingers undertook. The routines of embodiments of the present invention may be configured to require that the elapsed time between the first moment time and the second fall within certain limits. In one embodiment a minimum threshold of 200 milliseconds is employed and a maximum time threshold of 4000 milliseconds is employed. Thus, if each finger F moves substantially to the left within the certain time limits, a two-finger leftward finger gesture is determined to have been performed upon the playing video media file. By “substantially to the left,” it is generally meant that leftward changes in the location H of each finger are more than some predefined small threshold. In one embodiment the small threshold is 300% of the major axis of finger contact ellipse A of each finger. In response to the detection of a two-finger leftward finger gesture imparted within the display area of a playing piece of video media, the playing piece of video media is jumped backwards by one track, for example by one track of a DVD or DVD style data stored in memory. If media is being played from a playlist that indicates a sequential listing of media items to be played, the playing piece of media may be jumped back to the previous item on the playlist in response to the detection of a two-finger leftward swipe finger gesture. In this way a user may, for example, be watching a music video in a sequence of music videos defined by a playlist. The user may jump back to the previous the video in the playlist by simply performing a two-finger leftward swipe finger gesture upon the screen of the media player.

A person of skill in the art would appreciate that gestures that require a specific direction of motion such as, for example, rightward, leftward, upward, and downward, need not be perfectly oriented in that direction in order to be detected by the routines of the present invention. As shown in the FIGS., the arrows of finger motion may be skewed slightly and still may be easily recognizable by the routines of embodiments of the present invention as being substantially in the intended direction. In some embodiments, motions with a directional arrow that is too far skewed, i.e. that is more than some threshold angle away from the intended gesture direction, may be filtered out by routines. In this way a substantially diagonal finger motion may not be misinterpreted as one of leftward, rightward, upward, or downward.

For embodiments that compute the angular direction of the gesture in determining which of the plurality of finger gestures have been performed over the playing video media file, an additional finger gesture may be enabled that crosses the playing video media file in a substantially diagonal direction. In a preferred embodiment, it crosses from the upper left portion of the playing media file towards the lower right portion of the playing media file. Such a diagonal-swipe finger gesture may be detected by the routines of the present invention by virtue of it falling within a particular angular range across the playing video media file. Such a diagonal-swipe finger gesture may be mapped to a close function of the playing media file, stopping the play and closing the file. This is a fast and convenient way to end the playing of a video media file and close it such that other computing content may be displayed upon the screen. In some embodiments a diagonal-swipe finger gesture is detected as a gesture that meets both the requirements of a rightward-swipe finger gesture AND a downward-swipe finger gesture, at the same time, thus enabling its detection without the computation of direction of motion angles. In some embodiments the diagonal-swipe finger gesture is configured instead as a two-finger diagonal-swipe finger gesture, requiring the detection of two finger contacts during the diagonal swipe across the playing media file. This helps to avoid accidental user imparting of the diagonal-swipe finger gesture, which is particularly valuable when it is mapped to stopping and closing the playing video media file upon which it is performed. In such embodiments, the two-finger diagonal-swipe finger gesture is performed by a user such that it falls substantially upon the screen area of the playing video media file. In response to the detection of the gesture, the playing media file is stopped and closed.

The foregoing described embodiments of the invention are provided as illustrations and descriptions. They are not intended to limit the invention to the precise forms described. In particular, it is contemplated that functional implementation of the invention described herein may be implemented equivalently in hardware, software, firmware, and/or other available functional components or building blocks.

This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A method for controlling playback of video media on a handheld media player, comprising:
displaying the video media on a display of the handheld media player, wherein the display comprises a touch screen surface;
detecting that an area of the touch screen surface is being touched by a user, wherein the area of the touch screen surface is disposed on top of an area of the display on which the video media is being displayed;
determining whether the user has imparted a predetermined gesture on the touch screen surface such that the predetermined media is performed over the playing video media; and
performing a corresponding action relating to the playback of the video media in response to determining that the user has imparted the predetermined gesture over the playing video media.

2. The method of claim 1, wherein the user imparts a gesture by touching the touch screen surface with at least one finger.

3. The method of claim 1, wherein the performing the corresponding action relating to the playback of the video media comprises at least one of: playing the video media, pausing the video media, rewinding the video media, fast forwarding the video media, increasing a volume level, decreasing a volume level, tracking forward, tracking backward, increasing a playback speed of the video media, decreasing a playback speed of the video media, and advancing at least one frame of the video media.

4. The method of claim 3, wherein a static finger gesture imparted over a playing video media image causes the video media to be paused.

5. The method of claim 3, wherein a rightward-swipe finger gesture imparted over a playing video media causes the video media to be fast-forwarded.

6. The method of claim 3, wherein a leftward-swipe finger gesture imparted over a playing video media causes the video media to be rewound.

7. The method of claim 3, wherein an upward-swipe finger gesture imparted over a playing video media causes the output volume of the video media to be increased.

8. The method of claim 3, wherein a downward-swipe finger gesture imparted over a playing video media causes the output volume of the video media to be decreased.

9. The method of claim 3, wherein a double-tap finger gesture imparted over a paused video media causes the play of the video media to be resumed.

10. The method of claim 3, wherein a circular-swipe finger gesture imparted over a displayed video media causes the play of the video media to be restarted from the beginning.

11. The method of claim 3, wherein a two-finger rightward-swipe finger gesture imparted over a playing video media causes the play of the video media to be advanced by one or more track or section increments.

12. The method of claim 3, wherein a two-finger leftward-swipe finger gesture imparted over a playing video media causes the play of the video media to be rewound by one or more track or section increments.

13. The method of claim 3, wherein a diagonal-swipe finger gesture imparted over a playing video media causes the play of the video media to be ceased and closed.

14. The method of claim 1, wherein the determining the gesture is based at least partially on a comparison of data received from the touch screen surface with stored gesture data.

15. The method of claim 1, wherein the determining the gesture is based at least partially on a length of time that the user imparts the gesture.

16. A handheld video media player for controlling playback of video media, comprising:
a display to display the video media;
a touch screen surface disposed over the display;
a processor to
receive data from the touch screen surface and detect whether a user touches an area of the touch screen surface at least partially over an area of the display on which the video media is being displayed;
determining whether the user has imparted a predetermined gesture on the touch screen surface over the displayed video media; and
performing a corresponding action relating to the playback of the video media in response to determining that the user has imparted the predetermined gesture.

17. The handheld video media player of claim 16, wherein the touch screen surface is adapted to receive a gesture from the user in response to the user touching the touch screen surface with at least one finger.

18. The handheld video media player of claim 16, wherein the processor is adapted to perform the corresponding action relating to the playback of the video media comprising at least one of: playing the video media, pausing the video media, rewinding the video media, fast forwarding the video media, increasing a volume level, decreasing a volume level, tracking forward, tracking backward, increasing a playback speed of the video media, decreasing a playback speed of the video media, and advancing at least one frame of the video media.

19. The handheld video media player of claim 18, wherein the processor is adapted to perform at least a plurality of the following actions:
pause a playing video media in response to a static finger gesture being detected over a playing video media image;
fast-forward the playing video media in response to a rightward-swipe finger gesture being detected over the playing video media image;
rewind the playing video media in response to a leftward-swipe finger gesture being detected over the playing video media image;
increase a volume of the playing video media in response to an upward-swipe finger gesture being detected over the playing video media image;
decrease the volume of the playing video media in response to a downward-swipe finger gesture being detected over the playing video media image;
resume play of the playing video media file in response to a double-tap finger gesture being detected over a paused video media image;
restart the play of the playing video media file in response to a circular-swipe finger gesture being detected over a displayed video media image;
advance by a full track or section increment, the play of the video media file in response to a two-finger rightward-swipe finger gesture being detected over a displayed video media image; and
rewind by the full track or section increment, the play of the video media file in response to a two-finger leftward-swipe finger gesture being detected over a displayed video media image.

20. The handheld video media player of claim 16, further a memory to store gesture data, wherein the processor is adapted to determine the gesture based on a comparison of data received from the touch screen surface with the stored gesture data.

21. A video media player for controlling playback of video media, comprising:
a touch screen display to display the video media;
a processor to
receive data from the touch screen display and detect whether a user's finger touches an area of the touch screen display on which the video media is being displayed;
determining whether the user has imparted a predetermined gesture on the touch screen display; and
performing a corresponding action relating to the playback of the video media in response to determining that the user has imparted the predetermined gesture.

22. The video media player of claim 21, wherein the touch screen display is adapted to receive a gesture from the user in response to the user touching the touch screen display with at least one finger.

23. The video media player of claim 21, wherein the processor is adapted to perform the corresponding action relating to the playback of the video media comprising at least one of: playing the video media, pausing the video media, rewinding the video media, fast forwarding the video media, increasing a volume level, decreasing a volume level, tracking forward, tracking backward, increasing a playback speed of the video media, decreasing a playback speed of the video media, and advancing at least one frame of the video media.

24. The video media player of claim 23, wherein the processor is adapted to perform at least a plurality of the following actions:
pause a playing video media in response to a static finger gesture being detected over a playing video media image;
fast-forward the playing video media in response to a rightward-swipe finger gesture being detected over the playing video media image;
rewind the playing video media in response to a leftward-swipe finger gesture being detected over the playing video media image;
increase a volume of the playing video media in response to an upward-swipe finger gesture being detected over the playing video media image;
decrease the volume of the playing video media in response to a downward-swipe finger gesture being detected over the playing video media image;
resume play of the playing video media in response to a double-tap finger gesture being detected over a paused video media image;
restart the play of the playing video media file in response to a circular-swipe finger gesture being detected over a displayed video media image;
advance by a full track or section increment, the play of the video media file in response to a two-finger rightward-swipe finger gesture being detected over a displayed video media image; and
rewind by the full track or section increment, the play of the video media file in response to a two-finger leftward-swipe finger gesture being detected over the displayed video media image.

25. The video media player of claim 21, further a memory to store gesture data, wherein the processor is adapted to determine the gesture based on a comparison of data received from the touch screen display with the stored gesture data.
